(19) United States
(12) Patent Application Publication
(10) Pub. No.: US 2020/0101828 A1
(43) Pub. Date: Apr. 2, 2020

(54) GLASS RUN

(71) Applicant: TOYODA GOSEI CO., LTD., Kiyosu-shi (JP)

(72) Inventor: Takeshi OSHIMA, Kiyosu-shi (JP)

(21) Appl. No.: 16/532,718

(22) Filed: Aug. 6, 2019

(30) Foreign Application Priority Data
Sep. 27, 2018 (JP) 2018-181885
Dec. 27, 2018 (JP) 2018-244260

(51) Int. Cl. B60J 10/76; B60J 5/04; B60J 10/15

(52) U.S. Cl. CPC B60J 10/76; B60J 10/15; B60J 5/0402

(57) ABSTRACT

A glass run includes a glass run body having an approximately U-shaped cross section including a vehicle exterior-side side wall, a vehicle interior-side side wall, and a bottom wall, a vehicle exterior-side seal lip and a vehicle interior-side seal lip respectively extended from leading ends of the vehicle exterior-side side wall and the vehicle interior-side side wall toward an inner side of the glass run body, and a vehicle exterior-side molding lip and a vehicle interior-side molding lip respectively extended toward an outer side of the glass run body. A decorative sheet is applied to a vehicle exterior-side surface of the vehicle exterior-side molding lip. At least the portion where the decorative sheet is applied of the vehicle exterior-side molding lip is formed with a hard part using a hard material that is harder than a soft material.

### CROSS REFERENCE TO RELATED APPLICATIONS

This application claims the priority benefit of Japanese Patent Application Nos. 2018-181885 filed on Sep. 27, 2018 and 2018-244260 filed on Dec. 27, 2018. The entirety of the above-mentioned patent application is hereby incorporated by reference herein and made a part of this specification.

### BACKGROUND OF THE INVENTION

### (1) Field of the Invention

The present invention relates to a glass run that is to be attached to a door panel and seals the space between the door and the door glass.

### (2) Description of Related Art

As illustrated in FIG. 9, JP 2005-29109 A discloses a glass run 100 including a bottom wall 140, a glass run body 110 having an approximately U-shaped cross section formed by a vehicle exterior-side side wall 120 and a vehicle interior-side side wall 130 extending from the bottom wall 140, as well as a vehicle exterior-side seal lip 121 and a vehicle interior-side seal lip 131 extended toward the inner side of the glass run body 110 of the approximately U-shaped cross section from the leading ends of the vehicle exterior-side side wall 120 and the vehicle interior-side side wall 130, respectively. In addition, the glass run 100 also includes a vehicle exterior-side molding lip 122 and a vehicle interior-side molding lip 132 extended outward from the leading ends of the vehicle exterior-side side wall 120 and the vehicle interior-side side wall 130. Furthermore, a film member 600 made of an olefin resinous material is bonded to the vehicle exterior-side side face of the vehicle exterior-side molding lip 122 by thermal welding. The glass run 100 is manufactured by extrusion molding, for which the material is ethylene propylene diene rubber (EPDM). Also, the film member 600 is thermally welded after being vulcanized.

### SUMMARY OF THE INVENTION

However, when applying the film member 600, it is necessary to apply pressure to the vehicle exterior-side molding lip 122, and in the case of a soft material like the above, there is a problem in that the vehicle exterior-side molding lip 122 deforms due to the pressure, and application irregularities occur in the film member 600.

On the other hand, since the film member 600 is applied while the vehicle exterior-side molding lip 122 is in a temporarily deformed state, when the pressure disappears after application and the shape of the vehicle exterior-side molding lip 122 is restored, there is also a problem in that the film member 600 deforms and appearance defects such as wrinkles occur.

Furthermore, since pressure on the vehicle exterior-side molding lip 122 is applied not only in the case of application but also in the case of attaching the glass run 100 to a door panel terminal, the problem of the film member 600 deforming and appearance defects such as wrinkles occurring also exists in the latter case as well.

In order to solve the above problem, a first aspect of the present invention provides a glass run that is to be attached to an inner periphery of a door of a vehicle and formed with a soft material that guides a raising and lowering of a door glass, the glass run including a glass run body having an approximately U-shaped cross section including a vehicle exterior-side side wall, a vehicle interior-side side wall, and a bottom wall, a vehicle exterior-side seal lip and a vehicle interior-side seal lip respectively extended from leading ends of the vehicle exterior-side side wall and the vehicle interior-side side wall toward an inner side of the glass run body having the approximately U-shaped cross section; and a vehicle exterior-side molding lip and a vehicle interior-side molding lip respectively extended from the leading ends of the vehicle exterior-side side wall and the vehicle interior-side side wall toward an outer side of the glass run body having the approximately U-shaped cross section. A decorative sheet is applied to part or all of a vehicle exterior-side surface of the vehicle exterior-side molding lip, and at least the portion where the decorative sheet is applied of the vehicle exterior-side molding lip is formed with a hard part using a hard material that is harder than the soft material.

According to the first aspect of the present invention, in a glass run that is formed with a soft material, is to be attached to the inner periphery of a door, and guides the raising and lowering of a door glass, a decorative sheet is applied to part or all of a vehicle exterior-side surface of a vehicle exterior-side molding lip of the glass run, and in at least the portion of the vehicle exterior-side molding lip where the decorative sheet is applied, a hard part made of a hard material that is harder than the soft material is formed. As a result, when applying the decorative sheet to the vehicle exterior-side surface of the vehicle exterior-side molding lip, the vehicle exterior-side molding lip does not deform even if pressure is applied to the vehicle exterior-side molding lip, the decorative sheet can be applied to the vehicle exterior side of the vehicle exterior-side molding lip without irregularities, and the occurrence of appearance defects such as wrinkles can be prevented.

On the other hand, since the part other than the hard part is formed with the soft material, the glass run exhibits excellent seal performance and ability to track shape in the case of being attached to the terminal of a door panel, and the raising and lowering of a door glass can be performed smoothly.

According to a second aspect of the present invention, in the glass run, the hard part is extended continuously from the vehicle exterior-side molding lip to the vehicle exterior-side side wall.

In the case in which the portion where the hard part using the hard material exists only in the vehicle exterior-side molding lip, since the joining portion (the apex of a vehicle exterior-side side wall) between the vehicle exterior-side molding lip and the vehicle exterior-side side wall is formed with the soft material, when attaching the glass run to the door panel, a force in the direction of opening out to the vehicle exterior side tends to be exerted in the vehicle exterior-side molding lip having the hard part.

According to the second aspect of the present invention, because the hard part is extended continuously from the vehicle exterior-side molding lip to the vehicle exterior-side side wall, or in other words, because the portion formed with the hard part is formed from the vehicle exterior-side molding lip and going past the joining portion with the vehicle exterior-side side wall (the apex of the vehicle exterior-side side wall) to the vehicle exterior-side side wall, the vehicle exterior-side molding lip can be prevented from opening out to the vehicle exterior side, and compared to the case in which the portion where the hard part is formed exists only in the vehicle exterior-side molding lip, the seal performance between the vehicle exterior-side molding lip and the door panel can be improved.

According to a third aspect of the present invention, in the glass run, a rib is formed on the vehicle interior side of the hard part formed in the vehicle exterior-side molding lip. According to the third aspect of the present invention, because the rib is formed on the vehicle interior side of the hard part formed in the vehicle exterior-side molding lip, even if the glass run is subjected to an external force, by having the rib abut the door panel, the vehicle exterior-side molding lip can be prevented from moving in accordance with the deformation of the vehicle exterior-side side wall and trying to rotate the entire vehicle exterior-side side wall, and rattling of the vehicle exterior-side molding lip can be prevented.

According to a fourth aspect of the present invention, in the glass run, a molding lip abutting lip configured to seal a space between a vehicle exterior-side face of the door panel and the vehicle exterior-side molding lip when the glass run is mounted to the door panel is formed on a tip of the vehicle exterior-side molding lip.

According to the fourth aspect of the present invention, because a molding lip abutting lip that seals the space between a vehicle exterior-side face of the door panel and the vehicle exterior-side molding lip when the glass run is mounted to the door panel is formed on the tip of the vehicle exterior-side molding lip, even if the thickness or shape of the terminal of the door panel to which the glass run is attached changes, the molding lip abutting lip provided on the tip of the vehicle exterior-side molding lip flexibly deforms to abut the door panel.

As a result, the vehicle exterior-side molding lip is no longer demanded to deform, and the vehicle exterior-side molding lip can be formed with the hard material. Consequently, the occurrence of appearance defects such as wrinkles in the decorative sheet can be prevented, while in addition, the seal performance between the vehicle exterior-side face of the door panel and the vehicle exterior-side molding lip can be secured.

According to a fifth aspect of the present invention, in the glass run, a stiffness of the hard part is 85 international rubber hardness degrees (IRHD) or more and 95 IRHD or less, and a stiffness of the soft material is 70 IRHD or more and less than 85 IRHD. According to the fifth aspect of the present invention, because the stiffness of the hard part is 85 IRHD or more and 95 IRHD or less while the stiffness of the soft material is 70 IRHD or more and less than 85 IRHD, the portion that is the soft material exhibits excellent seal performance and ability to track shape in the case of attaching the glass run to the terminal of the door panel, and since the portion where the decorative sheet is applied is the hard part, the portion where the decorative sheet is applied does not deform even when pressure is applied. Consequently, the decorative sheet can be applied without irregularities, and the occurrence of appearance defects such as wrinkles can be prevented.

Note that in the case in which the stiffness of the hard part is less than 85 IRHD, since the vehicle exterior-side molding lip is flexible, the stiffness is low, the vehicle exterior-side molding lip deforms due to pressure, application irregularities of the decorative sheet occur, and furthermore, when the pressure disappears after application and the shape of the vehicle exterior-side molding lip is restored, the decorative sheet deforms and appearance defects such as wrinkles occur.

On the other hand, in the case in which the stiffness of the hard part exceeds 95 IRHD, the hard part of the vehicle exterior-side molding lip becomes too stiff, it becomes difficult to make the glass run curve along the curved face on the roof side of an automobile door, and the ability to track the shape of the roof side is degraded.

Also, in the case in which the stiffness of the soft material is less than 70 IRHD, the stiffness of the glass run body is low, and the seal performance between the glass run and the door panel falls. On the other hand, in the case in which the stiffness of the soft material is 85 IRHD or more, the glass run body becomes too stiff, and the ability to track the door panel and flange in the case of attaching the glass run to the door panel terminal is degraded.

A sixth aspect of the present invention provides a glass run in which an upper-edge glass run that is to be attached to an upper edge of an inner periphery of a door and a longitudinal-edge glass run that is to be attached to a longitudinal edge of the inner periphery of the door are connected in a corner part of the door, the glass run being formed with a soft material that guides a raising and lowering of a door glass, the glass run including: a glass run body having an approximately U-shaped cross section including a vehicle exterior-side side wall, a vehicle interior-side side wall, and a bottom wall; a vehicle exterior-side seal lip and a vehicle interior-side seal lip respectively extended from leading ends of the vehicle exterior-side side wall and the vehicle interior-side side wall toward an inner side of the glass run body having the approximately U-shaped cross section; and a vehicle exterior-side molding lip and a vehicle interior-side molding lip respectively extended from the leading ends of the vehicle exterior-side side wall and the vehicle interior-side side wall toward an outer side of the glass run body having the approximately U-shaped cross section. The vehicle exterior-side molding lip of the upper-edge glass run is formed with a hard part using a hard material that is harder than the soft material, the upper-edge glass run has a cutout part in which a part of the upper-edge glass run is cut out leaving the vehicle exterior-side molding lip, a corner part of the glass run to be connected to the longitudinal-edge glass run is formed at the cutout position, and the cutout part of the vehicle exterior-side molding lip of the upper-edge glass run has a projecting part that projects past the longitudinal-edge glass run in the corner part.

In the related art, for a glass run that is to be attached to a door frame, the leading ends of molding lips of an upper-edge glass run and a longitudinal-edge glass run are joined at an approximately right angle or in a rounded shape (R shape) such that the cross sections of the upper-edge glass run and the longitudinal-edge glass run are joined at a corner part of the door, with the upper-edge glass run and the longitudinal-edge glass run being substantially the same in terms of design. According to the sixth aspect of the present invention, the vehicle exterior-side molding lip of the upper-edge glass run is formed with the hard part using the hard material that is harder than the soft material, and moreover, the upper-edge glass run has a cutout part in which a part of the upper-edge glass run is cut out leaving the vehicle exterior-side molding lip, and a corner part of the glass run to be connected to the longitudinal-edge glass run is formed at the cutout position. Because the cutout part in the vehicle exterior-side molding lip of the upper-edge glass run has a projecting part that projects past the longitudinal-edge glass run in the corner part, it becomes possible for the upper-edge glass run to also exist on the longitudinal edge of the door frame (extending out to the end of the center pillar (B-pillar), for example), and a new design of the door using the glass run can be provided.

Also, since the vehicle exterior-side molding lip of the upper-edge glass run becomes a projecting part as it is, it is not necessary to separately form a projecting part during the mold forming of the corner part, making molding easy.

Furthermore, since the vehicle exterior-side molding lip is formed with the hard part using the hard material, in the corner part, the projecting part that projects out past the longitudinal edge is self-supporting, making it easy to utilize the shape of the projecting part to attach the glass run to the door frame.

According to a seventh aspect of the present invention, in the glass run, a decorative sheet is applied to the vehicle exterior-side molding lip of the upper-edge glass run. According to the seventh aspect of the present invention, since the decorative sheet is applied to the vehicle exterior-side molding lip of the upper-edge glass run, if applied to the entirety of the door on a side of the vehicle, a line due to the decorative sheet reflecting the curved shape of the upper edge of the door frame can be formed on the upper part of the door such that the line is connected in a single piece from the front to the back of the door of the vehicle, thereby increasing the luxuriousness of the vehicle and making it possible to increase the added value of the glass run.

In a glass run that is formed with a soft material, is to be attached to the inner periphery of a door of a vehicle, and guides the raising and lowering of a door glass, a decorative sheet is applied to part or all of a vehicle exterior-side surface of a vehicle exterior-side molding lip of the glass run, and in at least the portion of the vehicle exterior-side molding lip where the decorative sheet is applied, a hard part using a hard material that is harder than the soft material is formed. For this reason, when applying the decorative sheet to the vehicle exterior-side molding lip, the vehicle exterior-side molding lip does not deform even if pressure is applied to the vehicle exterior-side molding lip, the decorative sheet can be applied without irregularities, and the occurrence of appearance defects such as wrinkles can be prevented.

Because the rib is formed on the vehicle interior side of the vehicle exterior-side molding lip that is formed with the hard material, even if the glass run is subjected to an external force, by having the rib abut the door panel, the vehicle exterior-side molding lip can be prevented from moving in accordance with the deformation of the vehicle exterior-side side wall and trying to rotate the entire vehicle exterior-side side wall, and rattling of the vehicle exterior-side molding lip can be prevented.

Because a molding lip abutting lip that seals the space between the vehicle exterior-side face of the door panel and the vehicle exterior-side molding lip when the glass run is mounted to the door panel is formed on the tip of the vehicle exterior-side molding lip, even if the thickness or shape of the door panel terminal to which the glass run is attached changes, the molding lip abutting lip provided on the tip of the vehicle exterior-side molding lip bends to abut the door panel. Therefore, the vehicle exterior-side molding lip is no longer demanded to deform, and the vehicle exterior-side molding lip can be formed with the hard material.

The vehicle exterior-side molding lip of the upper-edge glass run is formed with the hard part using the hard material that is harder than the soft material, and moreover, the upper-edge glass run has a cutout part in which a part of the upper-edge glass run is cut out leaving the vehicle exterior-side molding lip, and a corner part of the glass run to be connected to the longitudinal-edge glass run is formed at the cutout position. Because the vehicle exterior-side molding lip of the upper-edge glass run has a projecting part that projects past the longitudinal-edge glass run in the corner part, a new design of the door using the glass run can be provided.

Also, since the vehicle exterior-side molding lip of the upper-edge glass run becomes a projecting part as it is, it is not necessary to separately form a projecting part during the mold forming of the corner part, making molding easy. Furthermore, since the vehicle exterior-side molding lip is formed with the hard part using the hard material, in the corner part, the projecting part that projects out past the longitudinal edge is self-supporting, making it easy to utilize the shape of the projecting part to attach the glass run to the door frame.

In the case in which the decorative sheet is applied to the vehicle exterior-side molding lip of the upper-edge glass run, if applied to the entirety of the door on a side of the vehicle, a line due to the decorative sheet reflecting the curved shape of the upper edge of the door frame can be formed on the upper part of the door such that the line is connected in a single piece from the front to the back of the door of the vehicle, thereby increasing the luxuriousness of the vehicle and making it possible to increase the added value of the glass run.

### BRIEF DESCRIPTION OF THE DRAWINGS

FIG. 1 is a front view of a door of an automobile;

FIG. 2 is a front view of a glass run used in an embodiment of the present invention;

FIG. 3 is an A-A cross section of FIG. 1 when the glass run according to a first embodiment of the present invention is attached to the door of the automobile;

FIG. 4 is an A-A cross section of FIG. 1 when the glass run according to a second embodiment of the present invention is attached to the door of the automobile;

FIG. 5 is an A-A cross section of FIG. 1 when the glass run according to a third embodiment of the present invention is attached to the door of the automobile;

FIG. 6 is an A-A cross section of FIG. 1 when the glass run according to a fourth embodiment of the present invention is attached to the door of the automobile;

FIG. 7 is a front view of the door of an automobile when the glass run according to a fifth embodiment of the present invention is attached to the door of the automobile;

FIG. 8 is a detailed view of the B part in FIG. 7; and

FIG. 9 is a cross section of a glass run according to the related art (JP 2005-29109 A).

### DETAILED DESCRIPTION OF PREFERRED EMBODIMENTS

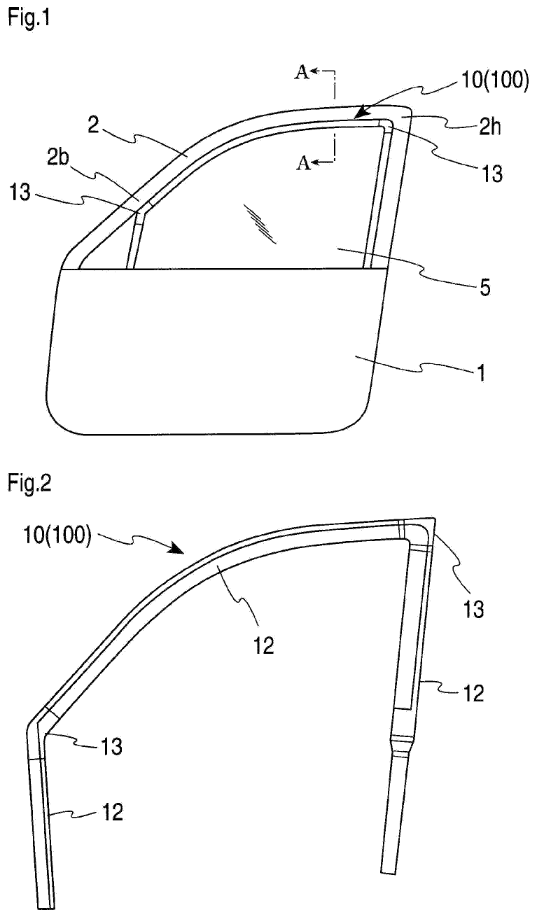

FIG. 1 is a front view of a door 1 on the front of an automobile, and FIG. 2 is a front view of a glass run 10 of the front door attached to a door frame 2 of the door 1. Note that although FIGS. 1 and 2 illustrate the front door on the left side of the automobile, the present invention is also applicable to the front door on the right side as well as to the left and right rear doors.

As illustrated in FIG. 1, the door frame 2 is provided on an upper part of the door 1, and the door glass 5 is attached so as to be freely raisable and lowerable. Additionally, the glass run 10 is attached to the inner periphery of the door frame 2, guiding the raising and lowering of the door glass 5 and also sealing the space between the door glass 5 and the door frame 2.

As illustrated in FIGS. 1 and 2, the glass run 10 generally includes a straight part 12 formed by extrusion molding, and a corner part 13 that is formed by mold forming, is to be attached to a corner part 2h of the door frame 2, and connects the above straight part 12. The straight part 12 includes a portion attached to an upper edge 2b of the door frame 2, a portion attached to a rear longitudinal edge of the door frame 2, and a portion attached to a sash forming a front longitudinal edge of the door frame 2.

In order to make these extrusion-molded portions take a shape corresponding to the door frame 2, in respective corner portions in the front and the rear, the corner part 13 molded by mold forming and connected to the straight part 12 is formed. Note that the corner part 13 of the glass run 10 is attached to the portion of the corner part 2h of the door frame 2.

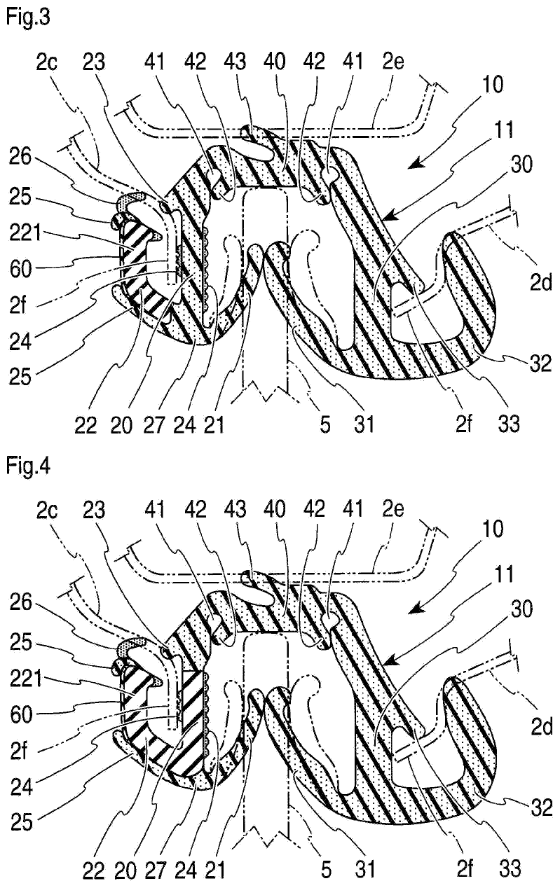

The glass run 10 according to the first embodiment of the present invention will be described on the basis of FIG. 3. FIG. 3 is a cross section view, taken along the A-A line in FIG. 1, of the glass run 10 attached to the upper edge 2b of the door frame 2 of the press-door type. A glass run body 11 includes a bottom wall 40 fitted into a sash, as well as a vehicle interior-side side wall 30 and a vehicle exterior-side side wall 20 that extend from the bottom wall 40. Also, a plurality of protrusions 24 are formed on both sides of the vehicle exterior-side side wall 20, and the protrusions 24 on the vehicle exterior side abut the vehicle interior side of a flange 2f of a door outer panel 2c. Note that it is desirable for the protrusions 24 to have a semicircular cross-sectional shape. Also, the protrusions 24 are formed at the same time as the vehicle exterior-side side wall 20 during extrusion molding.

Grooves 41 are formed to enable easier bending at the portions where the bottom wall 40 is continuous with the vehicle interior-side side wall 30 and the vehicle exterior-side side wall 20, and adjacent to the grooves 41, bottom wall holding lips 42 are formed on the door glass 5 side of the bottom wall 40. Meanwhile, on the side of the bottom wall 40 opposite from the door glass 5, a bottom wall abutting lip 43 is formed, and when the glass run 10 is attached to the door 1, the bottom wall abutting lip 43 abuts a door reinforcement panel 2e attached to the upper edge 2b of the door frame 2 and seals the space between the bottom wall 40 and the door reinforcement panel 2e.

From the approximate leading ends (apexes) of the vehicle interior-side side wall 30 and the vehicle exterior-side side wall 20, respectively, a vehicle interior-side seal lip 31 and a vehicle exterior-side seal lip 21 are extended toward the inner side (the bottom wall 40 direction) of the glass run body 11, by which the vehicle interior side and the vehicle exterior side of the door glass 5 become sealed respectively.

On the other hand, from the approximate leading end (apex) of the vehicle interior-side side wall 30, a vehicle interior-side molding lip 32 is extended in the direction of the vehicle interior. A door inner panel 2d is sandwiched between the vehicle interior-side molding lip 32 and the vehicle interior-side side wall 30. Also, on the vehicle interior side of the vehicle interior-side side wall 30, a vehicle interior-side holding lip 33 is formed going toward the leading end. A bend is formed in the door inner panel 2d, and this bend causes the vehicle interior-side holding lip 33 to be caught by the flange 2f and support the glass run 10 on the door frame 2.

On the vehicle exterior side near the portion where the vehicle exterior-side side wall 20 is continuous with the bottom wall 40, a vehicle exterior-side holding lip 23 that abuts the vehicle interior-side side face of the door outer panel 2c of the door frame 2 is formed going toward the leading end of the vehicle exterior-side side wall 20. The vehicle exterior-side holding lip 23 securely catches the vehicle exterior-side side wall 20 on the door outer panel 2c and supports the glass run 10 on the door frame 2.

On the other hand, from an apex 27 on the approximate leading end of the vehicle exterior-side side wall 20, a vehicle exterior-side molding lip 22 extending toward the vehicle exterior side is formed. Herein, in the vehicle exterior-side molding lip 22, the portion of the vehicle exterior-side side wall 20 farther on the vehicle exterior side than the apex 27 of the approximate leading end is formed with a hard part 221 using a hard material. For the hard material, polypropylene (PP) having a stiffness of 90 IRHD is used. Note that the hard part 221 may also be formed using another material as the hard material, such as nylon for example, insofar as the material has a stiffness of 85 IRHD or more and 95 IRHD or less.

The region in which to form the hard part 221 in the first embodiment is a region of the vehicle exterior-side molding lip 22 that does not include the joining portion between the vehicle exterior-side molding lip 22 and the vehicle exterior-side side wall 20, or in other words, does not include the apex 27 of the vehicle exterior-side side wall 20, and also is at least a region in which a decorative sheet 60 described later is applied. Consequently, the region of the hard part 221 includes not only the case in which the hard part 221 is the entire region of the vehicle exterior-side molding lip 22 not including the apex 27 of the vehicle exterior-side side wall 20, but also cases in which the hard part 221 is a partial region of the vehicle exterior-side molding lip 22 not including the apex 27 of the vehicle exterior-side side wall 20.

Also, in the first embodiment, the region of the hard part 221 of the vehicle exterior-side molding lip 22 is formed across the entire width of the vehicle exterior-side molding lip 22 from the vehicle exterior-side surface to the vehicle interior-side surface, except for regions where a covering part 25 using a soft material that covers both ends of the decorative sheet 60 described later is formed. However, as long as the decorative sheet 60 can be applied without irregularities to the vehicle exterior-side surface of the vehicle exterior-side molding lip 22 when pressure is imparted to the vehicle exterior-side molding lip 22, the soft material described later may also exist on the vehicle interior side of the vehicle exterior-side molding lip 22.

In the hard part 221 of the vehicle exterior-side molding lip 22, the decorative sheet 60 is applied to a part of the vehicle exterior-side surface. The sheet used for the decorative sheet 60 is one in which a brilliant layer containing metallic aluminum is formed by vapor deposition on a protective layer containing polyester, and in addition, an adhesive layer is provided on top of the brilliant layer. Note that the above decorative sheet 60 is for the case in which the decorative sheet 60 has a metallic luster, and another metal other than metallic aluminum, such as metallic indium for example, may also be used.

The decorative sheet 60 is applied by pressure bonding to the vehicle exterior-side molding lip 22 by reeling out the above decorative sheet 60 from a roll (not illustrated) while also pressing the adhesive layer of the decorative sheet 60 against the vehicle exterior-side surface of the vehicle exterior-side molding lip 22.

Note that in the first embodiment, the decorative sheet 60 is applied to a part of the vehicle exterior side of the hard part 221 of the vehicle exterior-side molding lip 22, but the decorative sheet 60 may also be applied to the entirety of the vehicle exterior-side surface of the hard part 221 of the vehicle exterior-side molding lip 22. The above is decided according to the design of the vehicle.

On the vehicle exterior side of the vehicle exterior-side molding lip 22, the covering part 25 using the soft material that covers both ends of the decorative sheet 60 is formed. With the covering part 25, it is possible to prevent peeling of the ends of the decorative sheet 60 and the intrusion of water and the like from the ends. Note that the covering part 25 may also be formed with the hard material similarly to the hard part 221 of the vehicle exterior-side molding lip 22.

Also, in the case in which measures are taken to prevent peeling of the ends and the intrusion of water and the like in the decorative sheet 60, the covering part 25 does not have to be formed.

On the leading end portion of the vehicle exterior-side molding lip 22, a molding lip abutting lip 26 using the soft material is formed in a shape curving convexly toward the vehicle exterior, or in other words, curving in the shape of a bow. When the glass run 10 is mounted to the door outer panel 2c, the molding lip abutting lip 26 bends, sealing the space between the vehicle exterior-side face of the door outer panel 2c and the vehicle exterior-side molding lip 22.

For the other portion of the vehicle exterior-side molding lip 22 excluding the hard part 221 in the first embodiment, a dynamically cross-linked thermoplastic elastomer (TPV) having a stiffness of 75 IRHD is used. Note that insofar as the soft material has a stiffness within the range of 70 IRHD or more and less than 85 IRHD, the soft material may also be formed with another material, such as EPDM or polyvinyl chloride, for example.

According to the first embodiment, in a glass run 10 that is formed with a soft material, is to be attached to the inner periphery of a door 1 or a vehicle, and guides the raising and lowering of a door glass 5, a decorative sheet 60 is applied to part of a vehicle exterior-side surface of a vehicle exterior-side molding lip 22 of the glass run, and in the portion of the vehicle exterior-side molding lip 22 where the decorative sheet 60 is applied, a hard part 221 using a hard material that is harder than the soft material is formed. As a result, when applying the decorative sheet 60 to the vehicle exterior-side molding lip 22, the vehicle exterior-side molding lip 22 does not deform even if pressure is applied to the vehicle exterior-side molding lip 22, the decorative sheet 60 can be applied to the vehicle exterior side of the vehicle exterior-side molding lip 22 without irregularities, and after that, occurrence of appearance defects such as wrinkles can be prevented.

Also, the molding lip abutting lip 26 using the soft material is formed on the leading end portion of the covering part 25 formed in the vehicle exterior-side molding lip 22, and when the glass run 10 is mounted to the door outer panel 2c, the bending of the molding lip abutting lip 26 makes it possible to seal the space between the vehicle exterior-side face of the door outer panel 2c and the vehicle exterior-side molding lip 22, and even if the thickness or shape of the door outer panel 2c to which the glass run 10 is attached changes, the change can be accommodated flexibly.

FIG. 4 is an A-A cross section of FIG. 1 when the glass run 10 according to a second embodiment of the present invention is attached to the door 1 of the automobile. The difference between the second embodiment and the above first embodiment is that in the second embodiment, the hard part 221 formed with the hard material is formed going past the joining portion between the vehicle exterior-side molding lip 22 and the vehicle exterior-side side wall 20 (the apex 27 of the vehicle exterior-side side wall 20) to the vehicle exterior-side side wall 20.

In the case in which the hard part 221 is formed only in the vehicle exterior-side molding lip 22 (first embodiment), since the joining portion between the vehicle exterior-side molding lip 22 and the vehicle exterior-side side wall 20 (the apex 27 of the vehicle exterior-side side wall 20) is formed with the above soft material, when the glass run 10 is attached to the door outer panel 2c, a force in the direction of the vehicle exterior-side molding lip 22 opening out to the vehicle exterior side tends to be exerted in the vehicle exterior-side molding lip 22.

According to the second embodiment, because the hard part 221 is extended continuously from the vehicle exterior-side molding lip 22 to the vehicle exterior-side side wall 20. In other words, because the hard part 221 is formed from the vehicle exterior-side molding lip 22 and going past the joining portion with the vehicle exterior-side side wall 20 (the apex 27 of the vehicle exterior-side side wall 20) to the vehicle exterior-side side wall 20, the vehicle exterior-side molding lip 22 can be prevented from opening out to the vehicle exterior side. As a result, compared to the case in which the portion where the hard part 221 is formed exists only in the vehicle exterior-side molding lip 22 (the first embodiment), the seal performance between the vehicle exterior-side molding lip 22 and the door outer panel 2c can be improved.

Note that in the second embodiment, with regard to the vertical direction of the vehicle, the hard part 221 extended to the vehicle exterior-side side wall 20 is formed up to slightly below the portion where the vehicle exterior-side holding lip 23 of the vehicle exterior-side side wall 20 is formed, but it is sufficient for the hard part 221 to be extended in the upward direction of the vehicle into the vehicle exterior-side side wall 20 past the joining portion between the vehicle exterior-side molding lip 22 and the vehicle exterior-side side wall 20.

Furthermore, from the perspective of preventing deformation in the vehicle exterior-side side wall 20 when the glass run 10 is attached to the door 1 of the automobile, the hard part 221 extended to the vehicle exterior-side side wall 20 is desirably extended above the tip of the flange 2f of the door outer panel 2c in the upward direction of the vehicle, such that the hard part 221 can abut the vehicle interior-side side face of the flange 2f through the protrusions 24.

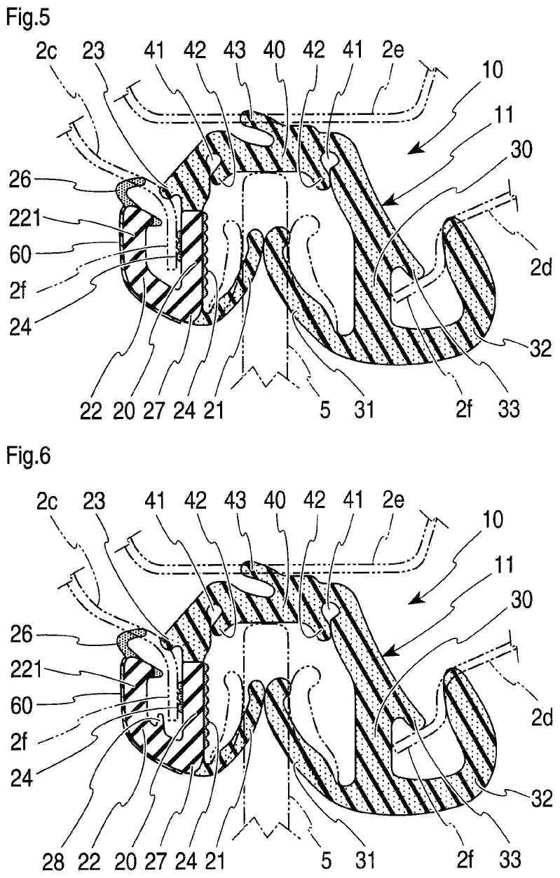

FIG. 5 is an A-A cross section of FIG. 1 when the glass run 10 according to a third embodiment of the present invention is attached to the door 1 of the automobile. The difference between the third embodiment and the above second embodiment is that in the third embodiment, the decorative sheet 60 is formed from the vehicle exterior-side molding lip 22 to the joining portion of the vehicle exterior-side molding lip 22 and the vehicle exterior-side side wall 20 (the apex 27 of the vehicle exterior-side side wall 20), and that the covering part 25 is not formed.

In the third embodiment, since the portion formed with the hard part 221 is formed from the vehicle exterior-side molding lip 22 and going past the joining portion with the vehicle exterior-side side wall 20 (the apex 27 of the vehicle exterior-side side wall 20), the vehicle exterior-side molding lip 22 does not open out to the vehicle exterior side, and the decorative sheet 60 can be applied from the vehicle exterior-side molding lip 22 over the joining portion with the vehicle exterior-side side wall 20 (the apex 27 of the vehicle exterior-side side wall 20) without appearance defects such as wrinkles occurring. As a result, because the area of the decorative sheet 60 can be expanded, the design of the vehicle can be flexibly accommodated.

FIG. 6 is an A-A cross section of FIG. 1 when the glass run 10 according to a fourth embodiment of the present invention is attached to the door 1 of the automobile. The difference between the fourth embodiment and the above third embodiment is that in the fourth embodiment, a rib 28 is formed on the vehicle interior side of the vehicle exterior-side molding lip 22 where the hard part 221 is formed.

As illustrated in FIG. 6, the rib 28 is formed on the vehicle interior side of the hard part 221 formed in the vehicle exterior-side molding lip 22, substantially parallel to the vehicle exterior-side side wall 20. Also, the spacing between the rib 28 and the vehicle exterior-side side wall 20 is slightly wider than the thickness of the flange 2f on the tip of the door outer panel 2c. Furthermore, the height of the rib 28 is a height at which the tip of the rib 28 becomes higher than the tip of the flange 2f of the tip of the door outer panel 2c in the upward direction of the vehicle when the glass run 10 is attached to the door 1 of the automobile.

As a result, even if the glass run 10 is subjected to an external force, by having the rib 28 abut the flange 2f on the tip of the door outer panel 2c, the vehicle exterior-side molding lip 22 is prevented from rotating, and rattling of the vehicle exterior-side molding lip 22 can be prevented.

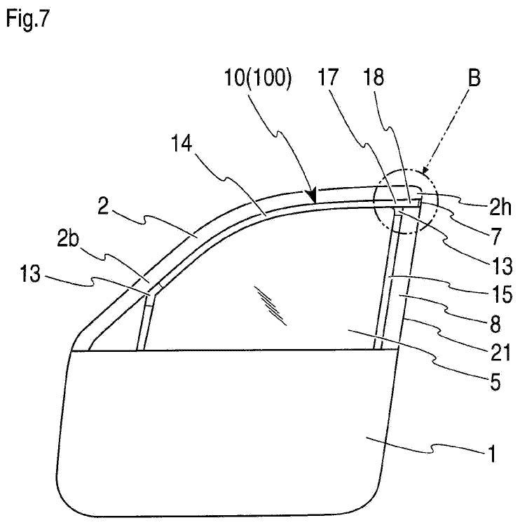

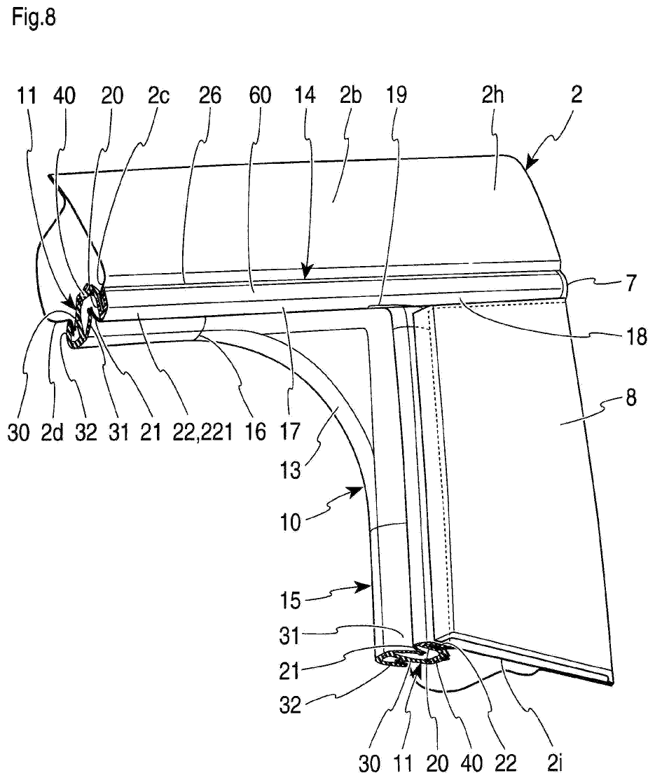

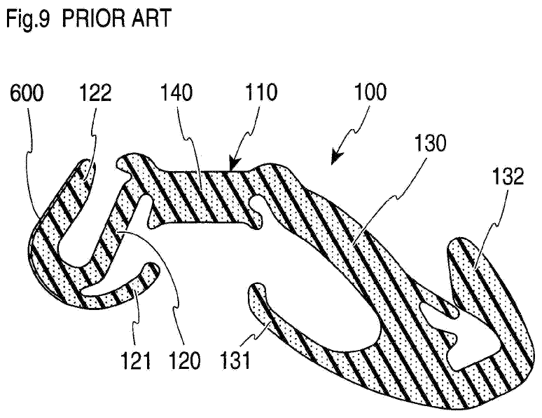

FIG. 7 is a front view of the door of an automobile when the glass run 10 according to a fifth embodiment of the present invention is attached to the door of the automobile, and FIG. 8 is a detailed view of the B part in FIG. 7. Note that although FIGS. 7 and 8 illustrate the front door on the left side of the automobile, the present invention is also applicable to the front door on the right side and to the left and right rear doors. The effect is particularly great in the case of application to the front and rear doors as a set. In the glass run 10 according to the present embodiment, the glass run according to the first embodiment of the present invention is used for an upper-edge glass run 14. Note that it is also possible to apply the glass runs according to the second, third, and fourth embodiments of the present invention to the upper-edge glass run 14.

In the present embodiment, the upper-edge glass run 14 attached to the upper edge 2b of the door frame 2 and a longitudinal-edge glass run 15 attached to a longitudinal edge 2i of the door frame 2 are connected in a corner part 2h of the door frame 2 to form the corner part 13 of the glass run 10.

The upper-edge glass run 14 and the longitudinal-edge glass run 15 both include the glass run body 11 having the approximately U-shaped cross section including the vehicle exterior-side side wall 20, the vehicle interior-side side wall 30, and the bottom wall 40, the vehicle exterior-side seal lip 21 and the vehicle interior-side seal lip 31 respectively extended from the leading ends of the vehicle exterior-side side wall 20 and the vehicle interior-side side wall 30 toward the inner side of the glass run body 11 having the approximately U-shaped cross section, and the vehicle exterior-side molding lip 22 and the vehicle interior-side molding lip 32 respectively extended from the leading ends of the vehicle exterior-side side wall 20 and the vehicle interior-side side wall 30 toward the outer side of the glass run body 11 having the approximately U-shaped cross section.

In the upper-edge glass run 14, the hard part 221 formed with a hard material, polypropylene (PP) having a stiffness of 90 IRHD is used. Note that the hard part 221 may also be formed using another material as the hard material, such as nylon for example, insofar as the material has a stiffness of 85 IRHD or more and 95 IRHD or less.

For the longitudinal-edge glass run 15 and the portion of the upper-edge glass run 14 excluding the hard part 221, a dynamically cross-linked thermoplastic elastomer (TPV) having a stiffness of 75 IRHD is used. Note that insofar as the soft material has a stiffness within the range of 70 IRHD or more and less than 85 IRHD, the soft material may also be formed with another material, such as EPDM or polyvinyl chloride, for example.

The upper-edge glass run 14 and the longitudinal-edge glass run 15 are both manufactured by extrusion molding, and later cut into fixed lengths. As illustrated in FIG. 8, in the upper-edge glass run 14, a cutout part 17 is formed in which other portions are cut out leaving the vehicle exterior-side molding lip 22. Additionally, in the upper-edge glass run 14, the corner part 13 is formed by mold forming and connected between a position 16 where the other portions are cut out and the longitudinal-edge glass run 15. As a result, in the corner part 13, a projecting part 18 that projects past the longitudinal-edge glass run 15 and to the right of the longitudinal-edge glass run 15 is formed in the cutout part 17 of the vehicle exterior-side molding lip 22 of the upper-edge glass run 14.

Note that in FIG. 8, in the corner part 13, a cutout part 19 on another level is formed in the vehicle exterior-side molding lip 22 where the other portions are cut out, but this is in consideration of bulging toward the vehicle exterior side by the vehicle exterior-side molding lip 22 of the longitudinal-edge glass run 15 in the corner part 13. The cutout part 19 does not have to be formed in cases where the bulging toward the vehicle exterior side by the vehicle exterior-side molding lip 22 of the longitudinal-edge glass run 15 is small.

The length of the upper-edge glass run 14 is adjusted such that when the glass run 10 is mounted to the door frame 2 of the door 1, the end of the projecting part 18 is substantially aligned with the trailing end of the longitudinal edge 2i of the door frame 2. Also, the length of the cutout part 17 is adjusted in consideration of the widths of the corner part 13 and the longitudinal edge 2i of the door frame 2.

After the glass run 10 is mounted to the door frame 2 of the door 1 and the projecting part 18 is secured to the longitudinal edge 2i of the door frame 2 with double-sided tape, for example, an end cap 7 that covers the end cross section of the upper-edge glass run 14 is mounted to the end of the projecting part 18. A pillar garnish 8 is mounted to the longitudinal edge 2i of the door 1, and the projecting part 18 of the upper-edge glass run 14 is mounted above the pillar garnish 8. Note that the present invention is also applicable to vehicles of a type not furnished with the pillar garnish 8.

In the present embodiment, because the upper-edge glass run 14 exists, due to the projecting part 18, out to the trailing end of the longitudinal edge 2i of the door frame 2 of the door 1, a new design of the door 1 using the glass run 10 can be provided. Particularly, in the present embodiment, since the decorative sheet 60 is applied to the vehicle exterior-side molding lip 22 of the upper-edge glass run 14, when the glass run of the present embodiment is also mounted to the rear doors, the decorative sheet 60 can be made to appear to exist continuously from the front doors to the rear doors. As a result, because an attractive line due to the decorative sheet 60 reflecting the curved shape of the upper edge of the doors can be formed with few seams on the upper part of the doors, the luxuriousness of the vehicle can be increased.

Also, since the vehicle exterior-side molding lip 22 of the upper-edge glass run 14 becomes a projecting part 18 as it is, it is not necessary to separately form a projecting part 18 during the mold forming of the corner part 13, making molding easy. Furthermore, since the vehicle exterior-side molding lip 22 is formed with the hard part 221 using the hard material, in the corner part 13, the projecting part 18 that projects out past the longitudinal-edge glass run 15 is self-supporting, making it easy to utilize the shape of the projecting part 18 to attach the glass run 10 to the door frame 2.

An embodiment of the present invention is not limited to the foregoing embodiments, and various modifications are possible without departing from the object of the present invention.

For example, all of the embodiments from the first to fifth embodiments of the present invention use the molding lip abutting lip 26 on the leading end portion of the vehicle exterior-side molding lip 22, but instead of using the molding lip abutting lip 26, the soft material may be used to thickly form the leading end portion of the vehicle exterior-side molding lip 22, that is, the tip past the hard part 221, such that when the glass run 10 is mounted to the door outer panel 2c, the leading end portion elastically abuts the door outer panel 2c.

For example, all of the embodiments from the first to fifth embodiments of the present invention use TPV with the same IRHD value for the soft material, but the stiffness may be altered depending on the site, and moreover, the soft material may be formed by different materials depending on the site.

What is claimed is:

1. A glass run that is to be attached to an inner periphery of a door and formed with a soft material that guides a raising and lowering of a door glass, the glass run comprising:
a glass run body having an approximately U-shaped cross section including a vehicle exterior-side side wall, a vehicle interior-side side wall, and a bottom wall;
a vehicle exterior-side seal lip and a vehicle interior-side seal lip respectively extended from leading ends of the vehicle exterior-side side wall and the vehicle interior-side side wall toward an inner side of the glass run body having the approximately U-shaped cross section; and
a vehicle exterior-side molding lip and a vehicle interior-side molding lip respectively extended from the leading ends of the vehicle exterior-side side wall and the vehicle interior-side side wall toward an outer side of the glass run body having the approximately U-shaped cross section,
wherein
a decorative sheet is applied to part or all of a vehicle exterior-side surface of the vehicle exterior-side molding lip, and
at least the portion where the decorative sheet is applied of the vehicle exterior-side molding lip is formed with a hard part using a hard material that is harder than the soft material.

2. The glass run according to claim 1, wherein the hard part is extended continuously from the vehicle exterior-side molding lip to the vehicle exterior-side side wall.

3. The glass run according to claim 1, wherein a rib is formed on a vehicle interior side of the hard part formed in the vehicle exterior-side molding lip.

4. The glass run according to claim 1, wherein a molding lip abutting lip configured to seal a space between a vehicle exterior-side face of the door panel and the vehicle exterior-side molding lip when the glass run is mounted to the door panel is formed on a tip of the vehicle exterior-side molding lip.

5. The glass run according to claim 1, wherein a stiffness of the hard part is 85 international rubber hardness degrees (IRHD) or more and 95 IRHD or less, and a stiffness of the soft material is 70 IRHD or more and less than 85 IRHD.

6. A glass run in which an upper-edge glass run that is to be attached to an upper edge of an inner periphery of a door and a longitudinal-edge glass run that is to be attached to a longitudinal edge of the inner periphery of the door are connected in a corner part of the door, the glass run being formed with a soft material that guides a raising and lowering of a door glass, the glass run comprising:
a glass run body having an approximately U-shaped cross section including a vehicle exterior-side side wall, a vehicle interior-side side wall, and a bottom wall;
a vehicle exterior-side seal lip and a vehicle interior-side seal lip respectively extended from leading ends of the vehicle exterior-side side wall and the vehicle interior-side side wall toward an inner side of the glass run body having the approximately U-shaped cross section; and
a vehicle exterior-side molding lip and a vehicle interior-side molding lip respectively extended from the leading ends of the vehicle exterior-side side wall and the vehicle interior-side side wall toward an outer side of the glass run body having the approximately U-shaped cross section,
wherein
the vehicle exterior-side molding lip of the upper-edge glass run is formed with a hard part using a hard material that is harder than the soft material,
the upper-edge glass run has a cutout part in which a part of the upper-edge glass run is cut out leaving the vehicle exterior-side molding lip,
a corner part of the glass run to be connected to the longitudinal-edge glass run is formed at the cutout position, and
the cutout part of the vehicle exterior-side molding lip of the upper-edge glass run has a projecting part that projects past the longitudinal-edge glass run in the corner part.

7. The glass run according to claim 6, wherein a decorative sheet is applied to the vehicle exterior-side molding lip of the upper-edge glass run.
